(19) United States
(12) Patent Application Publication
(10) Pub. No.: US 2008/0231868 A1
(43) Pub. Date: Sep. 25, 2008

(54) INFORMATION PROCESSING APPARATUS AND DRIVER CONTROL METHOD

(75) Inventor: Takahiro Onsen, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/050,046

(22) Filed: Mar. 17, 2008

(30) Foreign Application Priority Data
Mar. 23, 2007 (JP) 2007-077066

(51) Int. Cl. G06F 3/12

(52) U.S. Cl. 358/1.1; 358/1.15

(57) ABSTRACT

An image processing apparatus includes a driver control unit configured to perform processing relating to uninstallation or updating of a driver associated with a device, and a relay unit configured to switch a storage destination of device configuration information which has been transmitted from the device associated with the driver to another storage destination in response to switch information, and to store the device configuration information in the other storage destination.

### BACKGROUND OF THE INVENTION

1. Field of the Invention

The present invention relates to image processing apparatuses and methods for controlling device drivers.

2. Description of the Related Art

Installation of image forming systems is usually highly costly.

In order to install an image forming system, for example, a user first prepares image forming devices and installs device drivers for controlling the image forming devices in individual PCs (personal computers) constituting the image forming system. Then, the user manually operates user interfaces of the device drivers to obtain device configuration information from the image forming devices and sets the device configuration information in the device drivers.

Recently, techniques have been developed for installing image forming systems without the need for such manual operations for obtaining device configuration information with a view to reducing installation cost.

Specifically, in a technique which has been developed, an image forming system automatically acquires device configuration information from image forming devices connected over a network and automatically sets the acquired device configuration information in device drivers. In such an image forming system, automatic setting of device configuration information is permitted not only at the time of installation but also when the device configuration information of the image forming devices is updated.

An example of a technique for automatically acquiring and setting device configuration information is disclosed in, for example, Japanese Patent Laid-Open No. 2005-25755. Japanese Patent Laid-Open No. 2005-25755 discloses a system and a method for performing automatic configuration of a network printer after the network printer is installed.

In a system in which device configuration information is automatically obtained from an image forming device connected to a network and set in a corresponding device driver, a user or a system administrator may perform processing for uninstalling or updating the device driver.

However, there is a problem with such a system in that an error may occur if the device driver is uninstalled or updated while setting of the device configuration information of an image forming device is in progress.

When device configuration information is set in a device driver, processes in the device driver are activated; and the device driver in which the processes are activated may not be uninstalled due to the specifications of the OS (operating system). To prevent uninstallation of drivers, the OS issues error message if the device driver is uninstalled or updated while setting of the device configuration information of an image forming device is in progress.

### SUMMARY OF THE INVENTION

The present invention has been made in view of the above circumstances. Thus, an image processing apparatus according to an exemplary embodiment of the present invention includes a driver control unit configured to perform processing relating to uninstallation or updating of a driver associated with a device, and a relay unit configured to switch a storage destination of device configuration information which has been transmitted from the device associated with the driver to another storage destination in response to switch information, and to store the device configuration information in the other storage destination.

Other features and advantageous of the present invention will be apparent from the following description taken in conjunction with the accompanying drawings, in which like reference characters designate the same or similar parts throughout.

### BRIEF DESCRIPTION OF THE DRAWINGS

FIG. 1 is a block diagram illustrating an example of a configuration of an image forming system.

FIG. 2 is a block diagram illustrating an internal configuration of a client PC.

FIG. 3 is a block diagram illustrating details of software installed in a client PC.

FIG. 4 illustrates an example of device configuration information to be notified by an image forming device.

FIG. 5 illustrates an example of a device driver selection screen displayed by a device driver uninstall/update program.

FIG. 6 is an example of a format of device configuration information which a device driver uninstall/update program stores in an automatic update information storage section.

FIG. 7 is a flowchart illustrating a procedure of device driver uninstall processing performed by a device driver uninstall/update program operating on a client PC.

FIG. 8 is a flowchart illustrating a procedure of device configuration information transmission destination switch processing performed by an automatic update relay module operating on a client PC.

FIG. 9 is a flowchart illustrating a procedure of device configuration information storage processing performed by a device driver operating on a client PC.

FIG. 10 is a first flowchart illustrating a procedure of device update processing performed by a device driver uninstall/update program operating on a client PC.

FIG. 11 is a second flowchart illustrating a procedure of device update processing performed by a device driver uninstall/update program operating on a client PC.

### DESCRIPTION OF THE PREFERRED EMBODIMENTS

In the following, exemplary embodiments of the present invention are described with reference to the drawings.

### First Exemplary Embodiment

### [System Configuration]

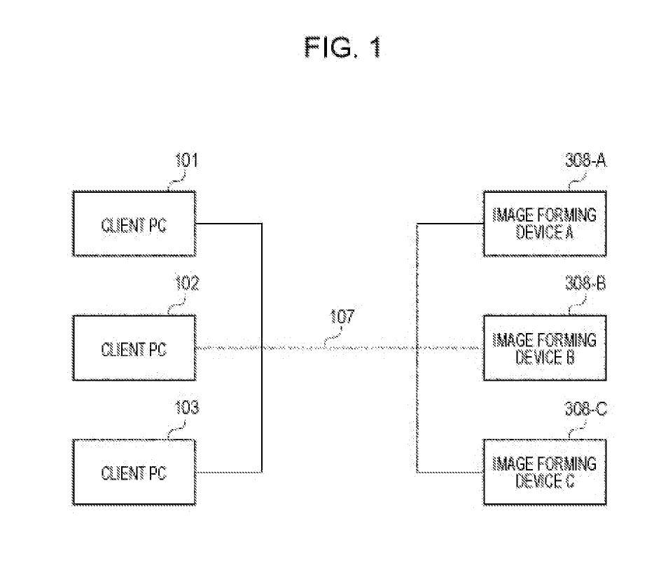

FIG. 1 is a block diagram illustrating an example of an image forming system.

As illustrated in FIG. 1, devices constituting the image forming system are connected over a network 107. This network 107 may be constituted by a single system or by multiple systems.

In FIG. 1, the image forming system includes client PCs 101, 102, and 103. The client PCs 101, 102, and 103 are, for example, information processing apparatuses (or computers) each capable of communicating with image forming devices connected over the network 107. In the present exemplary embodiment three image forming devices are connected to the network 107, namely an image forming device A (308-A), an image forming device B (308-B), and an image forming device C (308-C). Each of the image processing apparatuses has installed thereon an OS (operating system), device drivers for controlling the image forming devices, and software such as an image generation application. In the following description, the client PCs 101, 102, and 103 are each simply referred to as the client PC unless it is necessary to distinguish them from each other. Software according to the present exemplary embodiment is installed on the client PCs.

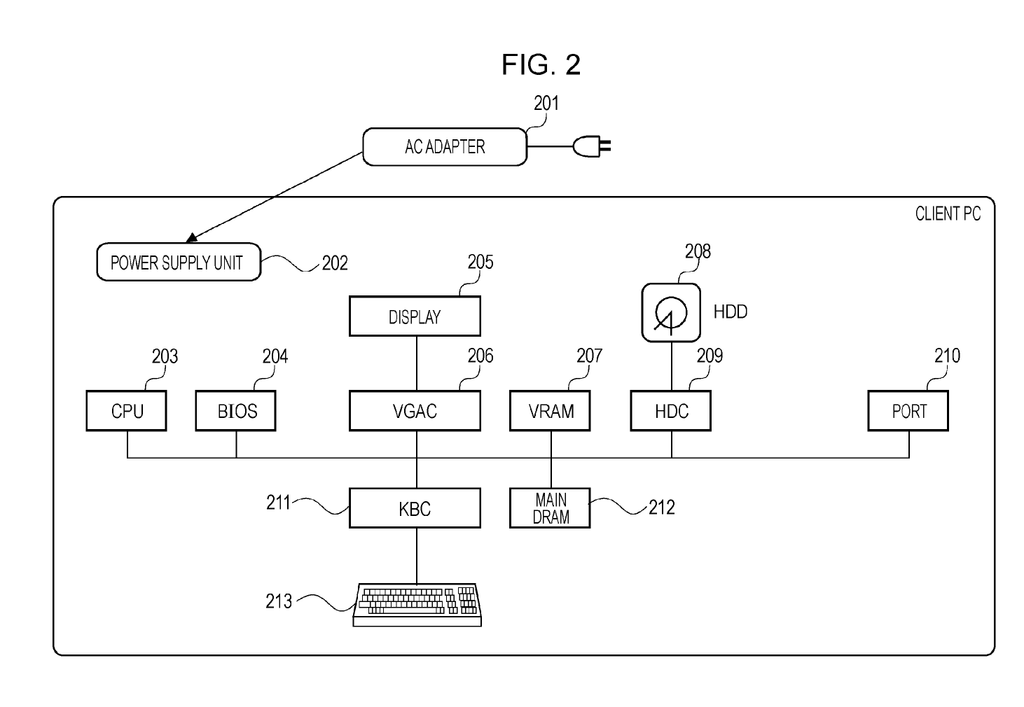

FIG. 2 is a block diagram illustrating an internal configuration of the client PC.

An external AC adapter 201 is provided as the source for driving the client PC.

The client PC includes a power source unit 202, a CPU (central processing unit) 203, a BIOS (basic input/output system) 204, a display 205 composed of an LCD (liquid crystal display), a video controller (VGAC: video graphic array controller) 206, a video memory (VRAM: video random access memory) 207, a hard disk drive (HDD) 208, a hard disk controller (HDC) 209, a network port (PORT) 210, a keyboard controller (KBC) 211, a system main memory (MAIN DRAM) 212, and a keyboard 213.

The power source unit 202 supplies electric power to these components of the client PC. The CPU 203 performs main control of the client PC. The BIOS 204 provides instructions regarding basic control of the components the client PC.

The HDD 208 is a writable non-volatile memory device which is controlled by the hard disk controller (HDC) 209.

The CPU 203 reads a program (software program) from the hard disk drive 208 and expands the read program in the system main memory 212. The CPU 203 executes the program using the system main memory 212. At this time, an image (or an icon) recorded in the VRAM 207 is displayed on the display 205 using the VGAC 206. In the system main memory 212, device configuration information, a flag, and other information are stored, which are described below.

Operation by a user is received through key input to the keyboard 213, and the keyboard controller 211 processes the key-input information. The PORT 210 communicates with an image forming device connected to a network.

Software such as an OS, an application, and a device driver is stored in the HDD 208 and executed by the CPU 203.

The user operates the software stored in the HDD 208 of the client PC to perform setting of an image forming system, acquire information from an image forming device, and carry out printing.

Referring back to FIG. 1, the image forming system includes image forming devices A, B, and C. In the present exemplary embodiment, when the configuration of the image forming device A 104 has been changed, the image forming device A 104 can communicate with the client PC to notify the client PC of its device configuration information. The image forming device A 104 is also capable of receiving electronic data from the client PC and performing printing processing.

The number of the client PCs and image forming devices constituting the image forming system is not limited to the case of the present exemplary embodiment.

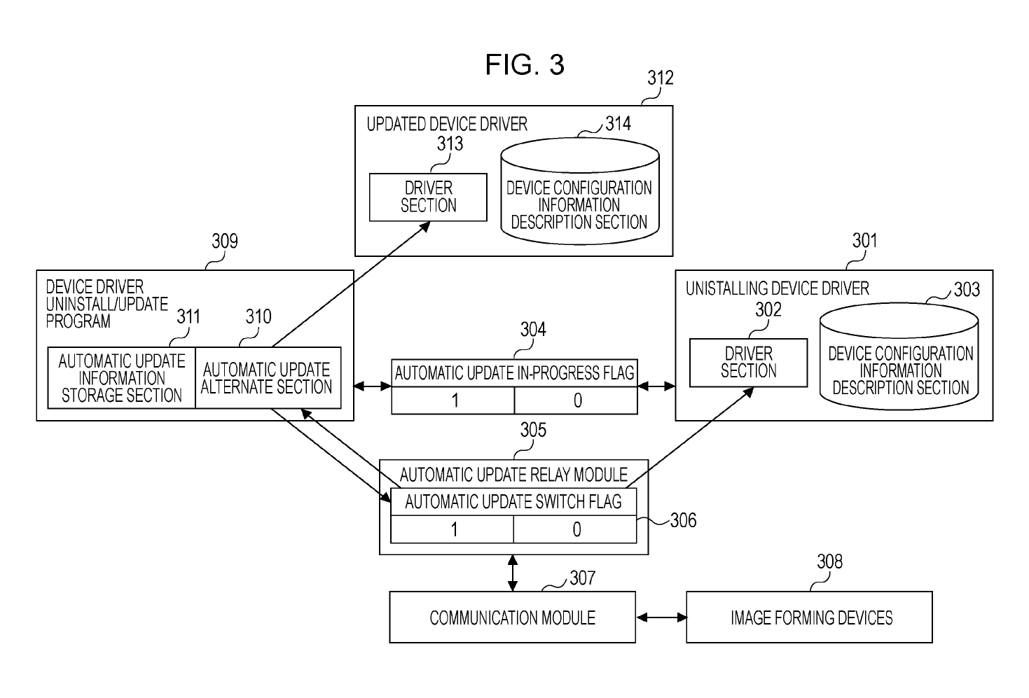

FIG. 3 is a block diagram illustrating details of software installed in the client PC. The software is composed of all the modules illustrated in FIG. 3 except for a communication module 307 and image forming devices 308. The client PC communicates with the image forming devices 308, such as the image forming devices A 104, B 105, and C 106, through the communication module 307.

The software illustrated in FIG. 3 enables the client PC to obtain device configuration information from each of the image forming devices 308 connected to a network and to uninstall or update a device driver while setting the obtained device configuration information in the device driver.

In FIG. 3, the software includes a device driver to be uninstalled (uninstalling device driver) 301. The uninstalling device driver 301 is composed of a driver section 302 and a device configuration information description section 303.

Note that each device driver is associated with a specific one of the image forming devices 308 and can control the associated image forming device.

The driver section 302 acquires device configuration information of an associated one of image forming devices 308 and stores the acquired device configuration information in the device configuration information description section 303. Hereinafter, the image forming devices 308 may each be referred to as the image forming device 308 unless it is necessary to distinguish them from each other.

The driver section 302 sets an automatic update in-progress flag 304 (a value “1” is set in the automatic update in-progress flag 304) before starting to record device configuration information in the device configuration information description section 303 and resets the automatic update in-progress flag 304 (a value “0” is set in the automatic update in-progress flag 304) after completing automatic update processing.

The automatic update in-progress flag 304 being in the set state (having the value of “1”) indicates that a corresponding device driver is currently performing device configuration information automatic update processing. On the other hand, the automatic update in-progress flag 304 being in the reset state (having the value of “0”) indicates that the corresponding device driver is not currently performing device configuration information automatic update processing. In FIG. 3, values “1” and “0” are both shown merely to provide an illustration of the possible values of the automatic update in-progress flag 304, but in operation one of the values is asserted at a time.

Although one automatic update in-progress flag is illustrated, it is to be understood that a respective automatic update in-progress flag 304 is provided for each device driver installed in the client PC.

An automatic update relay module 305 obtains device configuration information transmitted from the image forming device 308 through the communication module 307 and relays the device configuration information to higher-level software.

The automatic update relay module 305 has an automatic update switch flag 306.

If the automatic update switch flag 306 is in the set state (having a value of “1”), the automatic update relay module 305 transfers (or transmits) the device configuration information to a device driver uninstall/update program 309. If the automatic update switch flag 306 is in the reset state (having a value of “0”), the automatic update relay module 305 transfers (or transmits) the device configuration information to a device driver associated with that one of the image forming devices 308 from which the device configuration information has been transmitted.

The automatic update relay module 305 is a module independent of a device driver.

The automatic update switch flag 306 being in the set state indicates that device driver uninstall or update processing is currently being executed. The automatic update switch flag 306 being in the reset state indicates that uninstall or update processing is not currently being executed. In FIG. 3, values “1” and “0” are both shown merely to provide an illustration of the possible values of the automatic update switch flag 306, but in operation one of the values is asserted at a time.

Although one automatic update switch flag is illustrated, it is to be understood that a respective automatic update switch flag 306 is provided for each device driver installed in the client PC and each image forming device connected to the system.

The communication module 307 controls data communication between the image forming devices 308 and the automatic update relay module 305.

The client PC can receive device configuration information from the image forming device 308 via the network using the communication module 307. The client PC can also transmit device control information (such as a device configuration information NOTIFY command and a device configuration information NO-NOTIFY command) or printing data to the image forming device 308. The device configuration information NOTIFY command instructs the image forming device 308 to transmit its device configuration information, and the device configuration information NO-NOTIFY command instructs the image forming device 308 not to transmit its device configuration information.

The image forming device 308 has a function of printing out printing data transmitted from the client PC and a function of notifying a specific client PC of its device configuration information.

In the image forming device 308, an enable/disable state of notification of device configuration information and the timing of notification may be set through a local link or a remote link via a network. For example, the notification state of device configuration information can be set in the image forming device 308 from the client PC. Moreover, the image forming device 308 may be set so as to notify the device configuration information when the power is turned on or when the device configuration information has been changed. The image forming device 308 can also be configured to notify the device configuration information at predetermined time intervals or not to notify the device configuration information.

In the present exemplary embodiment, the image forming device C is configured to have a function of being remotely set as to whether device configuration information is to be notified or not (device configuration information NOTIFY/NO-NOTIFY setting) and a function of allowing remote setting of the notification timing.

The device driver uninstall/update program 309 is composed of an automatic update information storage section 311 and an automatic update alternate section 310. The device driver uninstall/update program 309 uninstalls a specific device driver installed in the client PC or updates the device driver to a newer device driver.

Specifically, the device driver uninstall/update program 309 performs the following processing (i.e., has the following functions).

Display a screen of a user interface (for example, a screen illustrated in FIG. 5 described below) on the display 205 and receive user input of selection of a specific device driver or an instruction of the execution of uninstall or update processing.

Suspend processing when the automatic update in-progress flag 304 is in the set state at the time of activation.

Set automatic update switch flag 306 when driver uninstall/update processing is in progress and reset the automatic update switch flag 306 when device driver uninstall/update processing is not in progress.

Send a device configuration information NO-NOTIFY command to one of the image forming devices 308 associated with the uninstalling device driver 301 when starting device driver uninstall/update processing.

Receive device configuration information of the image forming device 308 transmitted from the automatic update relay module 305 and store the received device configuration information in the automatic update information storage section 311 so as to be associated with image forming device identification information and device driver identification information.

Send the device configuration information which is stored in the automatic update information storage section 311 after an updated device driver 312 is installed to the updating device driver 312.

When information is stored in the automatic update information storage section 311 after the updated device driver 312 is installed, instruct the updated device driver 312 to acquire device configuration information from the image forming device 308.

In addition, when a device driver to be uninstalled or updated is currently performing any processing, the device driver uninstall/update program 309 may not uninstall or update the device driver.

This is because the OS enables uninstallation protection since the system is hung up (functions are stopped and thus processing is disabled) when uninstallation of a module related to processing currently in progress is attempted.

The automatic update alternate section 310 communicates with the automatic update relay module 305 to set or reset the automatic update switch flag 306. The automatic update alternate section 310 also communicates with the automatic update relay module 305 to acquire the device configuration information of the image forming device 308 and store the device configuration information in the automatic update information storage section 311.

The updated device driver 312 is composed of a driver section 313 and a device configuration information description section 314, similarly to the uninstalling device driver 301.

The device driver uninstall/update program 309 replaces the uninstalling device driver 301 with the updated device driver 312. At this time, the device configuration information of the image forming device 307 which has been stored in the uninstalling device driver 301 is transferred to the updated device driver 312.

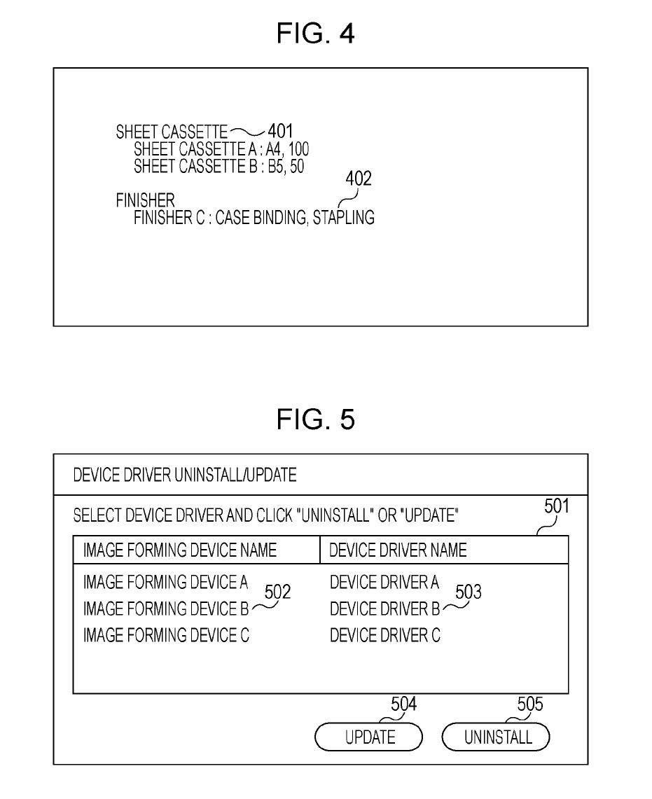

FIG. 4 illustrates an example of device configuration information to be notified by an image forming device.

As illustrated in FIG. 4, the device configuration information includes a sheet cassette information description portion 401, in which a type of sheet cassette provided in the image forming device 308, a sheet size supported by the image forming device 308, and the number of sheets are described.

The device configuration information also includes a finisher information description portion 402, in which a type of finisher provided in the image forming device 308 and a function supported by the image forming device 308.

In the example of FIG. 4, the device configuration information indicates that the image forming device has Cassette A with a capacity of 100 A4-size sheets, Cassette B with a capacity of 50 B5-size sheets, and Finisher C with a case binding function and a stapling function.

FIG. 5 illustrates an example of a screen displayed by the device driver uninstall/update program 309 for selecting a device driver (herein after referred to as a device driver selection screen).

In FIG. 5, the device driver selection screen includes a device driver list display area 501 composed of an image forming device name display portion 502 and a device driver name display portion 503.

In the image forming device name display portion 502, a list of names of image forming devices that are associated with specific device drivers is shown.

In the device driver name display portion 503, a list of names of device drivers installed in the client PC is shown.

In the example of FIG. 5, a device driver A, a device driver B, and a device driver C, which are associated with the image forming device A, the image forming device B, and the image forming device C, respectively, are installed in the client PC.

The user is allowed to select a device driver to be uninstalled or updated by selecting an image forming device name or a device driver name in the device driver list display area 501.

The device driver selection screen also includes an UPDATE button 504. When the user presses the UPDATE button 504 after selecting a device driver, the device driver uninstall/update program 309 starts device driver update processing.

Further, the device driver screen includes a UNINSTALL button 505. When the user presses the UNINSTALL button 505 after selecting a device driver, the device driver uninstall/update program 309 starts device driver uninstall processing.

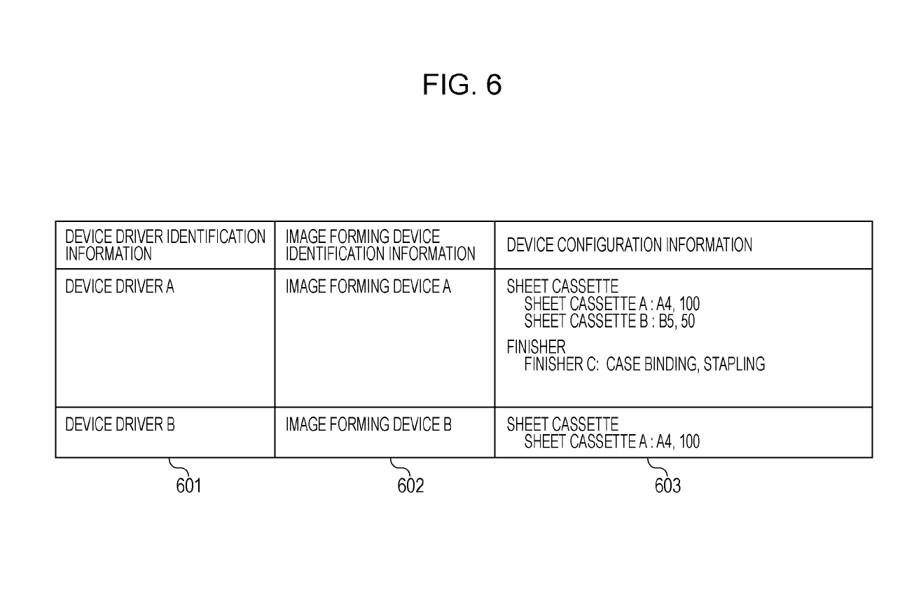

FIG. 6 illustrates an example of a format of device configuration information which the device driver uninstall/update program 309 stores in the automatic update information storage section 311.

In the example of the format illustrated in FIG. 6, a device driver identification information storage area 601, an image forming device identification information storage area 602, and a device configuration information storage area 603 are provided.

The device driver uninstall/update program 309 stores device configuration information in the format illustrated in FIG. 6. This allows the device driver uninstall/update program 309 to rapidly identify an image forming device which has been notified stored device configuration information and a device driver which is to be notified of the device configuration information.

Specifically, from the information described in FIG. 6 the device driver uninstall/update program 309 recognizes that device configuration information indicating “Cassette A with a capacity of 100 A4-size sheets, Cassette B with a capacity of 50 B5-size sheets, and Finisher C with a case binding function and a stapling function” is to be sent from the image forming device A to the device driver A, and that device configuration information indicating “Cassette A with a capacity of 100 A4-size sheets” is to be sent from the image forming device B to the device driver B.

### [Description of Processing]

### —Device Driver Uninstall Processing—

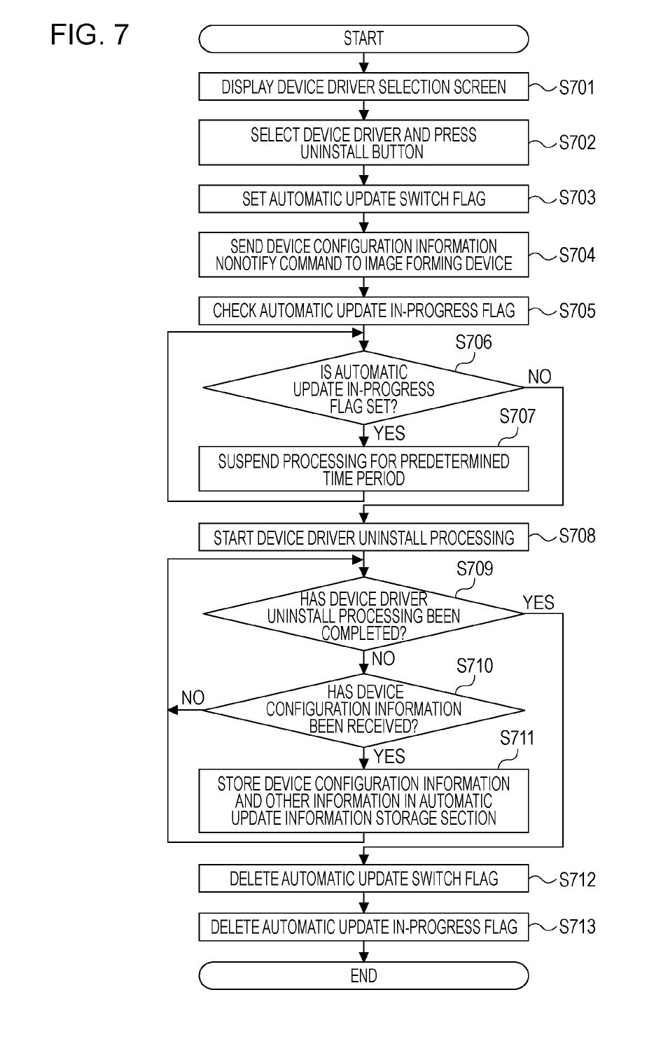

FIG. 7 is a flowchart illustrating a procedure of device driver uninstall processing performed by a device driver uninstall/update program 309 operating on a client PC. In the example of FIG. 7, processing of uninstalling the device driver A, the device driver B, and the device driver C presently installed in the client PC is performed while the occurrence of an error is prevented.

When a user operates the client PC to input an instruction to activate the device driver uninstall/update program 309, the device driver uninstall/update program 309 initiates the following processing.

At Step S701, the device driver uninstall/update program 309 displays the device driver selection screen illustrated in FIG. 5 on the display 205.

At Step S702, the device driver uninstall/update program 309 detects that the user has selected the device driver A, the device driver B, and the device driver C in the device driver list area 501 and then pressed the UNINSTALL button 505.

At Step S703, the device driver uninstall/update program 309 sets the automatic update switch flag 306 for each of the device driver A, the device driver B, and the device driver C to “1”.

Once the automatic update switch flag 306 is set, the automatic update relay module 305 specifies the automatic update alternate section 310 as the destination of the device configuration information to be transmitted from the image forming device A, the image forming device B, and the image forming device C.

At Step S704, the device driver uninstall/update program 309 sends the image forming device C a device configuration information NO-NOTIFY command. Since the image forming device A and the image forming device B do not have a function of being remotely set as to whether device configuration information is to be notified or not, no NO-NOTIFY command is sent to these image forming devices.

Upon receiving the device configuration information NO-NOTIFY command, the image forming device C discontinues the transmission of the device configuration information to the client PC.

At Step S705, the device driver uninstall/update program 309 checks the automatic update in-progress flag 304 for each of the device driver A, device driver B, and the device driver C.

At Step S706, the device driver uninstall/update program 309 determines whether the automatic update in-progress flag 304 for any of the device driver A, device driver B, and the device driver C is in the set state. If it is determined that the automatic update in-progress flag 304 is in the set state (YES in Step S706), the processing procedure proceeds to Step S707. At Step S707, the device driver uninstall/update program 309 suspends processing for uninstalling the device driver corresponding to the set automatic update in-progress flag 304 for a predetermined time period, and the processing procedure returns to Step S706.

The suspension period of the uninstall processing can be set by a user or the like at any time before the device driver uninstall/update program 309 is activated. In general, a time period slightly longer than the time period that a device driver takes to set device configuration information is set as the suspension period. It is also possible to set a predetermined time period beforehand in the device driver uninstall/update program 309.

If it is determined in Step S706 that the automatic update in-progress flag 304 is not in the set state (NO in Step S706), the processing procedure proceeds to Step S708. At Step S708, the device driver uninstall/update program 309 starts device driver uninstall processing.

Subsequently, at Steps S709 through S711, the device driver uninstall/update program 309 performs processing which is to be performed in a case where device configuration information is sent during the device driver uninstall processing.

Specifically, at Step S709, the device driver uninstall/update program 309 determines whether the device driver uninstall processing has been completed. If it is determined that the uninstall processing has not been completed (NO in Step S709), the device driver uninstall/update program 309 determines whether device configuration information has been received at Step S710.

If it is determined in Step S710 that device configuration information has been received (YES in Step S710), the processing procedure proceeds to Step S711. In Step S711, the device driver uninstall/update program 309 stores the received device configuration information, image forming device identification information of the image forming device from which the device configuration information has been received, and device driver identification information of the device driver to be notified of the device configuration information, in the automatic update information storage section 311 so as to be associated with each other.

In the present exemplary embodiment, it is assumed that the information described in FIG. 6 is stored in the automatic update information storage section 311. Upon completion of Step S711, the processing procedure returns to Step S709.

On the other hand, if it is determined in Step S710 that no device configuration information has been received, the processing procedure returns to Step S709. The device driver uninstall/update program 309 repeats the processing of Steps S709 through S711 until the device driver uninstall processing is completed.

If it is determined in Step S709 that the device driver uninstall processing has been completed (YES in Step S709), the processing procedure proceeds to Step S712.

At Step S712, the device driver uninstall/update program 309 deletes the automatic update switch flag 306 for each of the device driver A, the device driver B, and the device driver C.

At Step S713, the device driver uninstall/update program 309 deletes the automatic update in-progress flag 304 for each of the device driver A, the device driver B, and the device driver C, and the processing procedure illustrated in FIG. 7 is terminated.

### —Device Configuration Information Transmission (Storage) Destination Switch Processing—

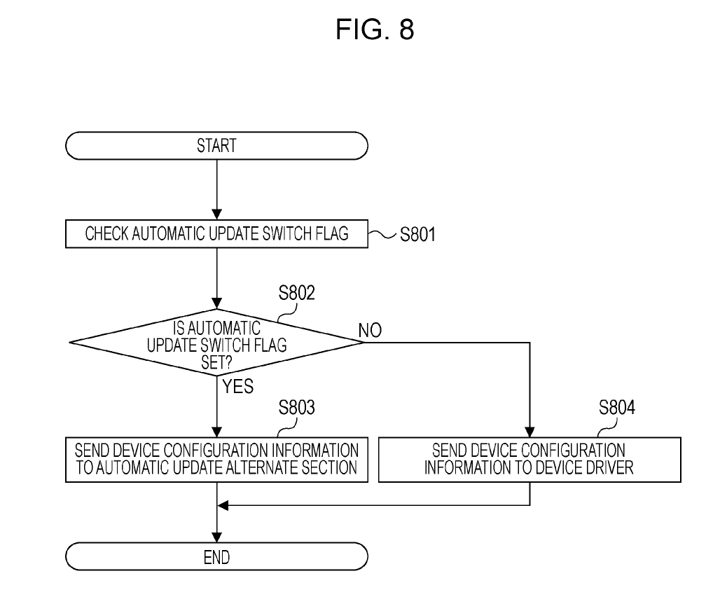

FIG. 8 is a flowchart illustrating processing for switching the transmission destinations of device configuration information which is performed by the automatic update relay module 305 operating on the client PC. In the following, transmission and reception of device configuration information to and from programs (drivers, etc.) are also referred to as storage of device configuration information in a predetermined storage area (storage destination) managed by the program which is the transmission destination of device configuration information.

When the automatic update relay module 305 receives device configuration information from one of image forming devices A to C via the communication module 307, the automatic update relay module 305 initiates the following processing.

At Step S801, the automatic update relay module 305 checks the automatic update switch flag 306 corresponding to the image forming device from which the device configuration information has been transmitted (or corresponding to the device driver associated with the image forming device).

At Step S802, the automatic update relay module 305 determines whether the automatic update switch flag 306 checked in Step S801 is in the set state.

If it is determined that the automatic update switch flag 306 is in the set state (YES in Step S802), the processing procedure proceeds to Step S803. At Step S803, the automatic update relay module 305 transfers (or transmits) the device configuration information to the automatic update alternate section 310. Upon completion of Step S804, the processing procedure of FIG. 8 ends.

On the other hand, if it is determined in Step S802 that the automatic update switch flag 306 is not in the set state (NO in Step S802), the processing procedure proceeds to Step S804. At Step S804, the automatic update relay module 305 transmits (or transfers) the device configuration information to the device driver associated with the image forming device from which the device configuration information has been transmitted. Upon completion of Step S804, the procession procedure of FIG. 8 ends.

### —Device Configuration Information Storage Processing—

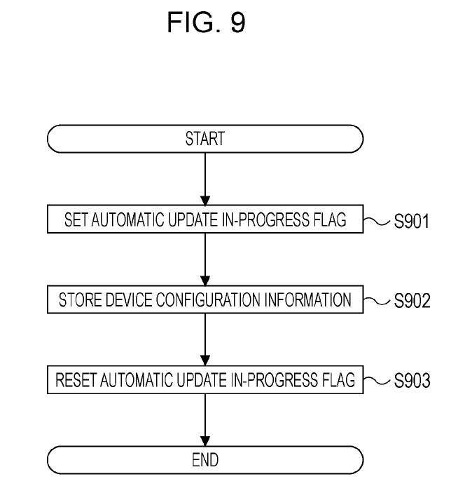

FIG. 9 is a flowchart illustrating a procedure of processing for storing device configuration information which is performed by a device driver operating on the client PC.

When the device driver receives device configuration information via the automatic update relay module 305, the device driver initiates the following processing.

At Step S901, the device driver sets the corresponding automatic update in-progress flag 304 to “1”.

At Step S902, the device driver stores the device configuration information received from the automatic update relay module 305 in the device configuration information description section.

Then, at Step S903, the device driver resets the automatic update in-progress flag 304 to “0”.

### —Device Driver Update Processing 1—

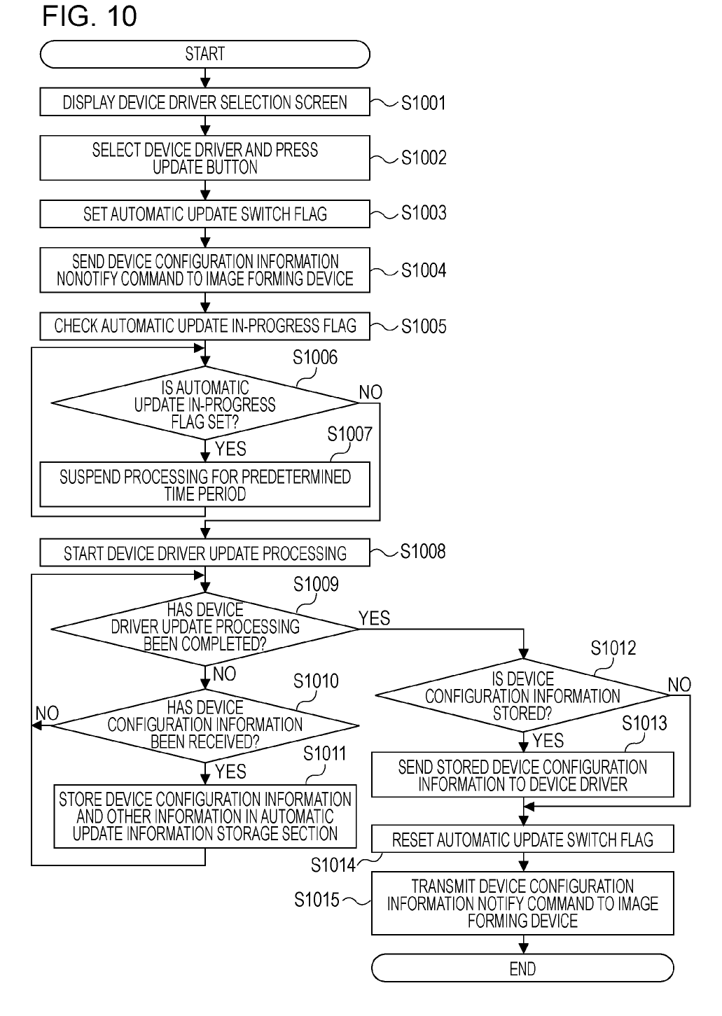

FIG. 10 is a first flowchart illustrating a procedure of device driver update processing which is performed by the device driver uninstall/update program 309 operating on the client PC. In the example of FIG. 10, processing for updating the device driver A, the device driver B, and the device driver C installed in the client PC is performed while the occurrence of an error is prevented.

When a user operates the client PC 101 to input an instruction for activating the device driver uninstall/update program 309, the device driver uninstall/update program 309 initiates the following processing.

At Step S1001, the device driver uninstall/update program 309 displays the device driver selection screen illustrated in FIG. 5 on the display 205.

At Step S1002, the device driver uninstall/update program 309 detects that the user has selected the device driver A, the device driver B, and the device driver C in the device driver list display area 501 and then pressed the UPDATE button 504.

At Step S1003, the device driver uninstall/update program 309 sets the automatic update switch flag 306 for each of the device driver A, the device driver B, and the device driver C to “1”.

Once the automatic update switch flag 306 is set, the automatic update relay module 305 specifies the automatic update alternate section 310 of the device driver uninstall/update program 309 as the transmission destination of device configuration information transmitted from the device driver A, the device driver B, and the device driver C.

At Step S1004, the device driver uninstall/update program 309 sends the image forming device C a device configuration information NO-NOTIFY command. Note that the image forming device A and the image forming device B do not have a function of being remotely set as to whether device configuration information is to be notified or not, and thus no NO-NOTIFY command is sent to these image forming devices.

Upon receiving the device configuration information NO-NOTIFY command, the image forming device C discontinues the transmission of the device configuration information.

Then, at Step S1005, the device driver uninstall/update program 309 checks the automatic update in-progress flag 304 for each of the device driver A, the device driver B, and the device driver C.

At Step 1006, the device driver uninstall/update program 309 determines whether the automatic update in-progress flag 304 for any of the device driver A, the device driver B, and the device driver C is in the set state. If it is determined that the automatic update in-progress flag 304 is in the set state (YES in Step S1006), the processing procedure proceeds to Step S1007. At Step S1007, the device driver uninstall/update program 309 suspends the update processing of the device driver corresponding to the set automatic update in-progress flag 304 for a predetermined time period, and the processing procedure returns to Step S1006.

The suspension period of the update processing may be set by a user or the like at any time before the device driver uninstall/update program 309 is activated. In general, a time period slightly longer than the time period that a device driver takes to set device configuration information is set as the suspension period. It is also possible to set a predetermined time period beforehand in the device driver uninstall/update program 309.

On the other hand, if it is determined in Step S1006 that the automatic update in-progress flag 304 for any of the device driver A, the device driver B, and the device driver C is not in the set state (NO in Step S1006), the processing procedure proceeds to Step S1008. In Step S1008, the device driver uninstall/update program 309 starts device driver update processing.

Subsequently, at Steps S1009 through S1011, the device driver uninstall/update program 309 performs processing which is to be performed in a case where device configuration information is received during the device driver update processing.

Specifically, at Step S1009, the device driver uninstall/update program 309 determines whether the device driver update processing has been completed. If it is determined that the device driver update processing has not been completed (NO in Step S1009), the device driver uninstall/update program 309 determines whether device configuration information has been received from any of the image forming devices A and B at Step S1010.

If it is determined in Step S1010 that device configuration information has been received (YES in Step S1010), the processing procedure proceeds to Step S1011. At Step S1011, the device driver uninstall/update program 309 stores the received device configuration information, the image forming device identification information of the image forming device from which the device configuration information has been received, and the device driver identification information of the device driver to be notified of the device configuration information, in the automatic update information storage section 311 so as to be associated with each other.

In the present exemplary embodiment, it is assumed that the information illustrated in FIG. 6 is stored in the automatic update information storage section 311. Upon completion of Step S1011, the processing procedure returns to Step S1009.

On the other hand, if it is determined in Step S1010 that no device configuration information has been received (NO in Step S1010), the processing procedure returns to Step S1009. The device driver uninstall/update program 309 repeats the processing of Steps S1009 through S1011 until the device driver update processing is competed.

If it is determined in Step S1009 that the device driver update processing has been completed (YES in Step S1009), the processing procedure proceeds to Step S1012. By this time, the device driver A, the device driver B, and the device driver C have been updated to newer device drivers.

At Step S1012, the device driver uninstall/update program 309 determines whether device configuration information is stored in the automatic update information storage section 311. If it is determined that device configuration information is not stored (NO in Step S1012), the processing procedure continues at Step S1014.

If it is determined that device configuration information is stored (YES in Step S1012), the device driver uninstall/update program 309 sends the stored device configuration information to the device driver associated with the device configuration information at Step S1013.

In the present exemplary embodiment, the information illustrated in FIG. 6 is assumed to be stored in the automatic update information storage section 311. Thus, the device driver uninstall/update program 309 sends device configuration information transmitted from the image forming device A to the updated device driver A and sends device configuration information transmitted from the image forming device B to the updated device driver B. Upon completion of Step S1013, the processing procedure continues at Step S1014.

At Step 1014, the device driver uninstall/update program 309 resets the automatic update switch flag 306 for each of the updated device driver A, the updated device driver B, and the updated device driver C to “0”.

Once the automatic update switch flag 306 is reset, the automatic update relay module 305 performs the following processing. Specifically, the automatic update relay module 305 specifies the updated device driver A, the updated device driver B, and the updated device driver C as the transfer destinations of the device configuration information transmitted from the image forming device A, the image forming device B, and the image forming device C, respectively.

Then, at Step S1015, the device driver uninstall/update program 309 sends a device configuration information NOTIFY command to the image forming device C, and the processing procedure is terminated.

Upon receiving the device configuration information NOTIFY command, the image forming device C starts the transmission of the device configuration information to the client PC.

### Second Exemplary Embodiment

### —Device Driver Update Processing 2—

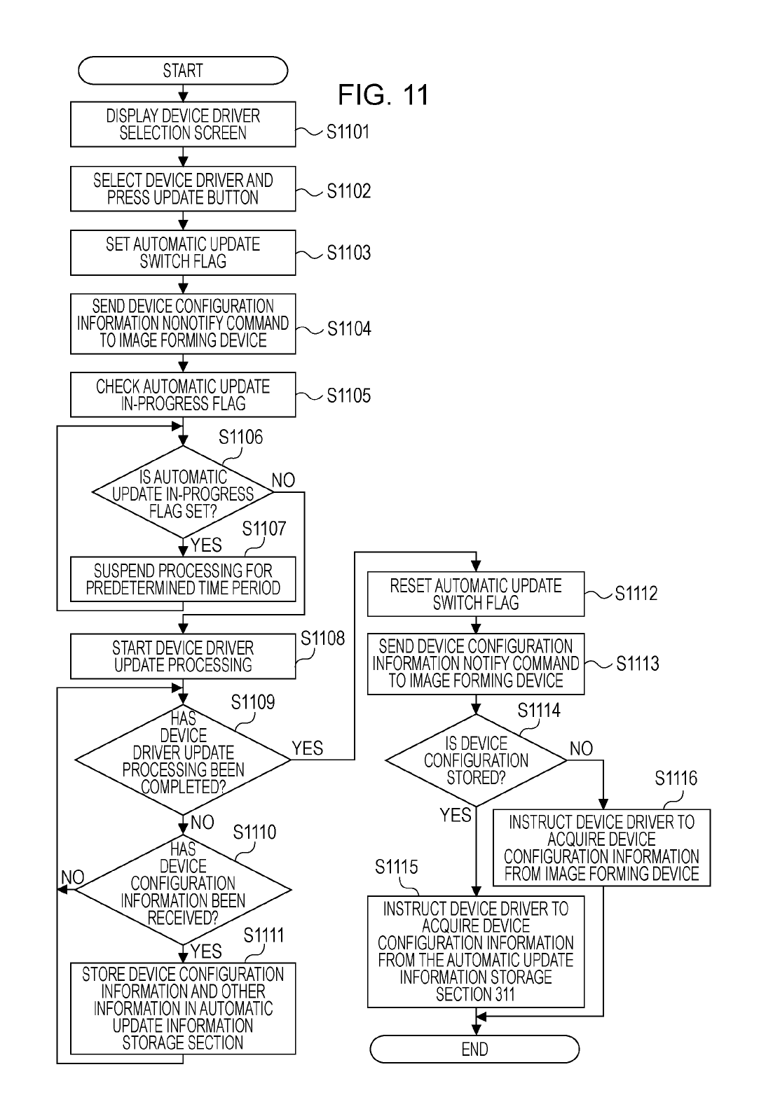

FIG. 11 is a second flowchart illustrating a procedure of device driver update processing which is performed by a device driver uninstall/update program 309 operating on a client PC. In the example of FIG. 11, processing for updating the device driver A, the device driver B, and the device driver C installed in the client PC is performed while the occurrence of an error is prevented.

Processing of Steps S1101 through S1111 in FIG. 11 is the same as the processing of Steps S1001 through S1011, so further description thereof is omitted.

At Step S1112, the device driver uninstall/update program 309 resets the automatic update switch flag 306 for each of the updated device driver A, the updated device driver B, and the updated device driver C to “0”.

Once the automatic update switch flag 306 is reset, the automatic update relay module 305 performs the following processing. Specifically, the automatic update relay module 305 specifies the updated device driver A, the updated device driver B, and the updated device driver C as the transfer destinations of device configuration information transmitted from the image forming device A, the image forming device B, and the image forming device C, respectively.

Then, at Step S1113, the device driver uninstall/update program 309 sends a device configuration information NOTIFY command to the image forming device C.

Upon receiving the device configuration information NOTIFY command, the image forming device C starts the transmission of the device configuration information to the client PC.

At Step S1114, the device driver uninstall/update program 309 determines whether device configuration information is stored in the automatic update information storage section 311.

If it is determined that device configuration information is stored in the automatic update information storage section 311 (YES at Step S1114), the device driver uninstall/update program 309 instructs the updated device driver A, the updated device driver B, and the updated device driver C to acquire the corresponding device configuration information at Step S1115.

Upon receiving the device configuration information acquire instruction, each of the updated device driver A, the updated device driver B, and the updated device driver C acquires the corresponding device configuration information from the automatic update information storage section 311 or associated one of the image forming devices and sets (or describes) the acquired device configuration information in its device configuration information description section.

More specifically, each of the updated device drivers inquires of the device driver uninstall/update program 309 whether corresponding device configuration information has been stored in the automatic update information storage section 311 (at Step S1114).

When receiving a response indicating that the corresponding device configuration information has been stored in the automatic update information storage section 311 (yes at Step S1114), uninstall/update program 309 instructs the updated device driver to acquire the corresponding device configuration information stored in the automatic update information storage section 311 (at S1115).

On the other hand, when receiving a response indicating that no corresponding device configuration information is stored in the automatic update information storage section 311 (no at S1114), uninstall/update program 309 instructs the updated device driver to acquire the corresponding device configuration information from the associated image forming device (at S1116).

Then, the processing illustrated in FIG. 11 is terminated.

### Other Exemplary Embodiments

Embodiments of the present invention also encompass the arrangements wherein a storage medium (or recording medium) storing a software program for realizing the functions of the above-described embodiments is supplied to a system or device having a computer (CPU or MPU) capable of reading program code from the storage medium and executing the program code. In this case, the program code read from the storage medium is also a feature that realizes the present invention. A computer program for implementing the function of the above-described embodiments may be encompassed in the present invention.

In addition to the functions of the above-described embodiment being realized by the program code read out being executed on a computer, the functions of the above-described embodiment may be realized by the Operating System (OS) running on the computer performing part or all of the actual processing based on instructions of the program code.

Moreover, the functions described above may be realized by the program code read out from the storage medium being written to memory provided in a function expansion card inserted into the computer or a function expansion unit connected to the computer, and the CPU of the function expansion board or function expansion unit performs part or all of actual processing on the basis of the instructions of the program code.

When the exemplary embodiments of the present invention are applied to the storage medium, program code corresponding to the above-described flowcharts is stored in the storage medium.

According to the exemplary embodiments described above, it is possible to prevent a driver uninstall error, which is likely to occur during the execution of uninstallation or updating of a device driver in which processes are activated. This enhances operability for users.

In addition, according to exemplary embodiments, the newest change of device configuration information of an image forming device which occurs during processing of updating a device driver can be reflected on the updated device driver. This also enhances operability for users.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-077066 filed on Mar. 23, 2007, which is hereby incorporated by reference herein in its entirety.

What is claimed is:

1. An image processing apparatus comprising:
a driver control unit configured to perform processing relating to at least one of uninstallation and updating of a driver associated with a device; and
a relay unit configured to switch a storage destination of device configuration information to an other storage destination in response to switch information, the device configuration information having been transmitted from the device associated with the driver, and to store the device configuration information in the other storage destination.

2. The image processing apparatus of claim 1,
wherein the relay unit stores the device configuration information
in the driver control unit when a value indicating that the driver control unit is currently performing the processing relating to at least one of uninstallation and updating of the driver is set in the switch information, and
in a storage area managed by the driver when a value indicating that the driver control unit is not currently performing the processing relating to at least one of uninstallation and updating of the driver is set in the switch information.

3. The image processing apparatus of claim 1,
wherein when the driver control unit starts the processing relating to at least one of uninstallation and updating of the driver, the driver control unit sets the value indicating that the driver control unit is currently performing the processing relating to at least one of uninstallation and updating of the driver in the switch information corresponding to the device associated with the driver.

4. The image processing apparatus of claim 1,
wherein the driver control unit stores device configuration information transmitted from the relay unit in a storage section, and when the device configuration information corresponding to the driver is stored in the storage section after updating the driver, transmits the device configuration information to the updated driver.

5. The image processing apparatus of claim 1,
wherein when starting the processing relating to at least one of uninstallation and updating of the driver, the driver control unit sends the device associated with the driver a command indicating that transmission of the device configuration information is to be stopped.

6. The image processing apparatus of claim 1,
wherein when terminating the processing relating to at least one of uninstallation and updating of the driver, the driver control unit sends the device associated with the driver a command indicating that the transmission of the device configuration information is to be started.

7. A driver control method for an image processing device, the driver control method comprising:
performing processing relating to at least one of uninstallation and updating of a driver associated with a device; and
switching a storage destination of device configuration information to an other storage destination in response to switch information, the device configuration information having been transmitted from the device associated with the driver, and storing the device configuration information in the other storage destination.

8. The driver control method of claim 7,
wherein in the switching, the device configuration information is stored
in a driver control unit configured to perform the processing relating to at least one of uninstallation and updating of the driver, when a value indicating that the processing relating to at least one of uninstallation and updating of the driver is currently in progress is set in the switch information, and
in a storage area managed by the driver when a value indicating that the processing relating to at least one of uninstallation and updating of the driver is not currently in progress is set in the switch information.

9. The driver control method of claim 7,
wherein in the performing, when the processing relating to at least one of uninstallation and updating of the driver is started, the value indicating that the processing relating to uninstallation or updating of the driver is currently in progress is set in the switch information corresponding to the device associated with the driver.

10. The driver control method of claim 7,
wherein in the performing, the device configuration information transmitted in the switching is stored in a storage section, and when the device configuration information corresponding to the driver is stored in the storage section after the driver is updated, the device configuration information is transmitted to the updated driver.

11. The driver control method of claim 7,
wherein in the performing, when the processing related to at least one of uninstallation and updating of the driver is started, a command indicating that transmission of the device configuration information is to be stopped is sent to the device associated with the driver.

12. The driver control method of claim 7,
wherein in the performing, when the processing related to at least one of uninstallation and updating of the driver is terminated, a command indicating that the transmission of the device configuration information is to be started is sent to the device associated with the driver.

13. A computer-readable storage medium storing a program causing a computer to function as:
a driver control unit configured to perform processing relating to at least one of uninstallation and updating of a driver associated with a device; and
a relay unit configured to switch a storage destination of device configuration information to an other storage destination in response to switch information, the device configuration information having been transmitted from the device associated with the driver, and to store the device configuration information in the other storage destination.
